(19) United States
(12) Patent Application Publication
(10) Pub. No.: US 2025/0053726 A1
(43) Pub. Date: Feb. 13, 2025

(54) WORK GENERATING METHOD, ELECTRONIC DEVICE AND STORAGE MEDIUM

(71) Applicant: Beijing Zitiao Network Technology Co., Ltd., Beijing (CN)

(72) Inventors: Mengting BAO, Beijing (CN); Xinyi LI, Beijing (CN); Zuxian YANG, Beijing (CN); Dongxing JIA, Beijing (CN)

(21) Appl. No.: 18/793,724

(22) Filed: Aug. 2, 2024

(30) Foreign Application Priority Data
Aug. 8, 2023 (CN) 202310996010.4

(51) Int. Cl. G06F 40/166; G06F 3/04886

(52) U.S. Cl. CPC G06F 40/166; G06F 3/04886

(57) ABSTRACT

Embodiments of the present disclosure provide a work generating method and apparatus, an electronic device and a storage medium. The method includes: receiving initial work information under a plurality of dimensions input by a user; in which the plurality of dimensions include at least one selected from a group consisting of work scene, work role and work synopsis; displaying supplementary prompt information generated according to the initial work information; in which the supplementary prompt information is used for prompting supplementation of the initial work information under a target dimension; generating and displaying work outline information according to the initial work information supplemented based on the supplementary prompt information; in which the work outline information includes work summary outline information and work detailed outline information; in response to a work generation request initiated based on work outline information, generating and displaying a target work corresponding to the work outline information.

This application claims the priority of Chinese Patent Application No. 202310996010.4 filed on Aug. 8, 2023, the disclosure of which is incorporated by reference herein in its entirety as part of the present application.

### TECHNICAL FIELD

The present disclosure relates to fields of computer technology and natural language processing, and specifically, to a work generating method and apparatus, an electronic device and a storage medium.

### BACKGROUND

In the traditional writing process, most writers face many difficulties such as insufficient creative inspiration, lack of proficiency in writing skills, and unclear text structure, which may lead to delay of the writing process of the writers and decline in text quality.

With development and popularization of the artificial intelligence (AI) technology, the AI technology has been widely applied in various fields, and may be applied in the field of writing. However, the existing AI text generation technologies still have some limitations, for example, most of the works generated by the existing AI text generation technologies have problems such as lack of vivid vocabulary and heavy traces generated by AI; and usually, in the current AI text generation technologies, works are usually generated directly based on story settings input by users, resulting in lack of plot content and poor quality of the generated works.

### SUMMARY

Embodiments of the present disclosure at least provide a work generating method and apparatus, an electronic device and a storage medium.

In the first aspect, embodiments of the present disclosure at least provide a work generating method, the method includes:

receiving initial work information under a plurality of dimensions input by a user; in which the plurality of dimensions include at least one selected from a group consisting of work scene, work role and work synopsis;

displaying supplementary prompt information generated according to the initial work information; in which the supplementary prompt information is used for prompting supplementation of the initial work information under a target dimension;

generating and displaying work outline information according to the initial work information supplemented based on the supplementary prompt information; in which the work outline information includes work summary outline information and work detailed outline information, each summary outline corresponds to a plurality of work detailed outlines; and

in response to a work generation request initiated based on the work outline information, generating and displaying a target work corresponding to the work outline information.

In an optional implementation, the displaying supplementary prompt information generated according to the initial work information includes:

displaying the supplementary prompt information and candidate supplementary information corresponding to the supplementary prompt information; and

acquiring initial work information under the target dimension that the user has re-edited based on the supplementary prompt information; or, determining target supplementary information selected by the user from the candidate supplementary information, and determining the initial work information supplemented based on the target supplementary information.

In an optional implementation, before the generating a target work corresponding to the work outline information in response to a work generation request initiated based on the work outline information, the method further includes:

receiving feedback suggestion information input by the user for the work outline information, in which the feedback suggestion information includes suggestion information for at least one outline attribute; and

regenerating the work outline information according to feedback suggestion information and the initial work information.

In an optional implementation, after the generating the work outline information, and before the receiving the work generation request, the method further includes:

receiving an edit operation performed by the user on a portion of outline information in the work outline information, determining the portion of outline information updated, and determining remaining outline information associated with the portion of outline information; and

updating the remaining outline information according to the portion of outline information updated.

In an optional implementation, the generating work outline information according to initial work information supplemented based on the supplementary prompt information, includes:

generating and displaying the work summary outline information based on the initial work information supplemented; each entry of work summary outline information corresponding to a chapter;

generating work detailed outline information under a target chapter corresponding to the work summary outline information in response to a detailed outline generation request of any entry of work summary outline information; and

displaying the work detailed outline information and first detailed outline prompt information; in which the first detailed outline prompt information is used for prompting new work role information generated for the target chapter; and the new work role information includes role attribute information and relationship information with other roles.

In an optional implementation, displaying second detailed outline prompt information when displaying the work detailed outline information; in which the second detailed outline prompt information includes supplementary suggestion information for the work detailed outline information, the supplementary suggestion information includes plot suggestion information and/or role suggestion information; and

determining the work detailed outline information after the user edits the work detailed outline based on the second detailed outline prompt information.

In an optional implementation, the receiving initial work information under a plurality of dimensions input by a user includes:

receiving work scene information input by the user;

displaying work synopsis information generated based on the work scene information; and

in response to an edit confirm operation for the work synopsis information, displaying information of each role generated based on the work synopsis information.

In an optional implementation, the generating and displaying work outline information includes:

displaying work outline information generated by an artificial intelligence model in real time, and real-time generation progress information corresponding to the work outline information.

In an optional implementation, the displaying work outline information generated by the artificial intelligence model in real time, and real-time generation progress information corresponding to the work outline information, includes:

hiding a keyboard operation region used for user edition in a process of generating the work outline information by the artificial intelligence model in real time, to expand a display region of a content generated by the artificial intelligence model; and

displaying the keyboard operation region after the artificial intelligence model has generated the work outline information, to facilitate the user to edit the work outline information based on the keyboard operation region.

In the second aspect, the embodiments of the present disclosure further provide a work generating apparatus, which includes:

a receiving module, configured to receive initial work information under a plurality of dimensions input by user; in which the plurality of dimensions include at least one selected from a group consisting of work scene, work role and work synopsis;

a display module, configured to display supplementary prompt information generated according to the initial work information; in which the supplementary prompt information is used for prompting supplementation of the initial work information under a target dimension;

a first generating module, configured to generate and display work outline information according to the initial work information supplemented based on the supplementary prompt information; in which the work outline information includes work summary outline information and work detailed outline information, each work summary outline corresponds to a plurality of detailed outlines; and

a second generating module, configured to generate and display a target work corresponding to the work outline information in response to a work generation request initiated based on the work outline information.

In the third aspect, the embodiments of the present disclosure further provide an electronic device, which includes a processor, a memory, and a bus, in which the memory stores computer-readable instructions executable by the processor; and when the electronic device is running, the processor communicates with the memory through the bus, and the computer-readable instructions, when executed by the processor, execute steps of the work generating method in the first aspect or any optional implementation in the first aspect.

In the fourth aspect, the embodiments of the present disclosure further provide a computer readable storage medium, the computer readable storage medium stores a computer program thereon; the computer program, when run by a processor, executes the work generating method in the first aspect or any optional implementation in the first aspect.

### BRIEF DESCRIPTION OF DRAWINGS

To describe technical solutions of the embodiments of the present disclosure more clearly, the accompanying drawings required in the description of the embodiments will be described briefly below. The accompanying drawings, which are hereby incorporated in and constitute a part of the present description, illustrate embodiments of the present disclosure, and together with the description, serve to explain the principles of the embodiments of the present disclosure. Apparently, the following drawings only illustrate some embodiments of the present disclosure and should not be regarded as limiting the scope of the present disclosure, other accompanying drawings can also be derived from these drawings by those ordinarily skilled in the art without creative efforts.

FIG. 1 shows a flow chart of a work generating method provided by an embodiment of the present disclosure;

FIG. 2a shows a schematic diagram of an interface before receiving initial work information in a work generating method provided by an embodiment of the present disclosure;

FIG. 2b shows a schematic diagram of an interface when inputting work scene information in a work generating method provided by an embodiment of the present disclosure;

FIG. 3a shows a schematic diagram of a display interface for entering a work synopsis creation stage from a previous stage in a work generating method provided by an embodiment of the present disclosure;

FIG. 3b shows a schematic diagram of an interface when editing input work synopsis information in a work generating method provided by an embodiment of the present disclosure;

FIG. 3c shows a schematic diagram of an interface in which AI generates work synopsis information in a work generating method provided by an embodiment of the present disclosure;

FIG. 3d shows a schematic diagram of an interface in which AI has generated work synopsis information in a work generating method provided by an embodiment of the present disclosure;

FIG. 4a shows a schematic diagram of a display interface for entering a role information creation stage from a previous stage in a work generating method provided by an embodiment of the present disclosure;

FIG. 4b shows a schematic diagram of an interface in which AI generates role information in a work generating method provided by an embodiment of the present disclosure;

FIG. 4c shows a schematic diagram of an interface when manually adding role information in a work generating method provided by an embodiment of the present disclosure;

FIG. 5 shows a schematic diagram of a display interface of supplementary prompt information in a work role creation stage in a work generating method provided by an embodiment of the present disclosure;

FIG. 6a shows a schematic diagram of a display interface for entering a work summary outline creation stage from a previous stage in a work generating method provided by an embodiment of the present disclosure;

FIG. 6b shows a schematic diagram of an interface in which AI generates a work summary outline in a work generating method provided by an embodiment of the present disclosure;

FIG. 6c shows a schematic diagram of an interface for manually adding work summary outline information in a work generating method provided by an embodiment of the present disclosure;

FIG. 6d shows a schematic diagram of an interface of a summary outline list in a work generating method provided by an embodiment of the present disclosure;

FIG. 7a shows a schematic diagram of a display interface for entering a work detailed outline creation stage from a previous stage in a work generating method provided by an embodiment of the present disclosure;

FIG. 7b shows a schematic diagram of an interface for selecting a summary outline from a list in a work generating method provided by an embodiment of the present disclosure;

FIG. 7c shows an interface in which AI generates a work detailed outline in a work generating method provided by an embodiment of the present disclosure;

FIG. 7d shows a schematic diagram of an interface when editing work detailed outline information in a work generating method provided by an embodiment of the present disclosure;

FIG. 8a shows a schematic diagram of an interface for selecting a detailed outline in a work generating method provided by an embodiment of the present disclosure;

FIG. 8b shows a schematic diagram of generating work information based on selected detailed outline in a work generating method provided by an embodiment of the present disclosure;

FIG. 8c shows a schematic diagram of an interface for finally generating a target work in a work generating method provided by an embodiment of the present disclosure;

FIG. 9 shows a structural schematic diagram of a work generating apparatus provided by an embodiment of the present disclosure; and

FIG. 10 shows a schematic diagram of a computer device provided by an embodiment of the present disclosure.

### DETAILED DESCRIPTION

In order to make objectives, technical details, and advantages of the embodiments of the present disclosure clearer, the technical solutions of the embodiments will be described in a clearly and fully understandable way in connection with the drawings related to the embodiments of the present disclosure. Apparently, the described embodiments are just a part but not all of the embodiments of the present disclosure. The components of the disclosed embodiments described and illustrated in the accompanying drawings may be arranged and designed in various different configurations. Therefore, the detailed description of the embodiments in the accompanying drawings is not intended to limit the scope of the present disclosure, but only to represent the selected embodiments of the present disclosure. Based on the disclosed embodiments, all other embodiments obtained by those skilled in the art without creative labor fall within the protection scope of the present disclosure.

Through research, it is found that, AI technology has made significant progress in various fields, especially in natural language processing and generation aspects, which has created conditions for applying AI technology to the field of writing. There are some tools on the market that can automatically generate works according to text content pre-input by a user; but in specific applications, the generated works usually have many problems such as rigid content of work text, excessive traces generated by AI, and lack of detail description, etc. Although efficiency of work generation is improved, work quality fails to meet expectations.

Based on the above research, embodiments of the present disclosure provide a work generating method, in which a multi-stage creation process is adopted to create a work stage by stage, for example, firstly, guiding the user to input some necessary creative elements for an artificial intelligence model to generate a work summary outline and a work detailed outline, and then generate the work based on the work summary outline and the work detailed outline; such a way helps the artificial intelligence model understand creative intentions, improve completeness of the work structure and richness of detail content; besides, in this process, by providing input prompts to the user, the user may easily and quickly participate in the creation process while minimizing time costs of active thinking of the user, thereby assisting the artificial intelligence model in generating works of better quality.

The shortcomings of the above solutions are all the research results of the inventor(s) through practice and careful study. Therefore, the discovery process of the above problems and solutions proposed in the present disclosure with respect to the above problems in the following text should all be the contributions made by the inventor(s) to the present disclosure.

The technical solutions of the present disclosure will be described in a clearly and fully understandable way in connection with the accompanying drawings of the present disclosure. It is obvious that the described embodiments are just a part but not all of the embodiments of the present disclosure. Generally, the components of the present disclosure, described and shown in the accompanying drawings, may be arranged and designed in various different configurations. Therefore, the detail description provided by the embodiments of the present disclosure illustrated in the accompanying drawings is not intended to limit the scope of the present disclosure, but only to represent the selected embodiments of the present disclosure. Based on the embodiments of the present disclosure, those skilled in the art can acquire other embodiment(s), without any inventive work, which should be within the scope of the present disclosure.

It should be noted that: similar reference signs and letters indicate similar items in the drawings below, and therefore once a certain item is defined in one drawing, it does not need to be further discussed in subsequent drawings.

For convenience of understanding this embodiment, firstly a work generating method disclosed in the embodiments of the present disclosure is introduced in detail; an executing body of the work generating method provided by the embodiments of the present disclosure is usually a computer device having certain computing function; the computer device, for example, includes: a terminal device, a server, or other processing device; the terminal device may be a user equipment (UE), a mobile device, a user terminal, a terminal, a cellular phone, a cordless phone, a personal digital assistant (PDA), a handheld device, a computing device, a vehicle-mounted device, a wearable device, etc. In some possible implementations, the work generating method may be implemented by a processor calling computer readable instructions stored in a memory.

Taking the executing body being a terminal device as an example to illustrate the work generating method provided by the embodiments of the present disclosure.

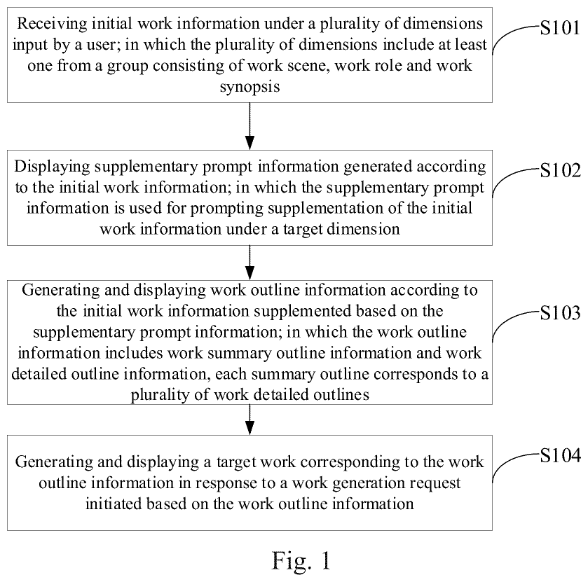

Referring to FIG. 1, it is a flow chart of a work generating method provided by an embodiment of the present disclosure; and the method includes step S101 to step S104.

S101: receiving initial work information under a plurality of dimensions input by a user; in which the plurality of dimensions include at least one selected from a group consisting of work scene, work role and work synopsis.

Here, a creation process of the initial work information is firstly carried out; the creation process may be divided into a plurality of stages; these stages may correspond to different dimensions of the initial work information; for example, these stages may include a work scene setting stage, a work synopsis creation stage, and a work role creation stage. The work scene setting is for the user to firstly make some basic direction settings for the work that needs to be created, for example, work style, story background, emotional tendencies, etc.; the work synopsis creation is to generate a basic plot outline on the basis of the work scene, similar to a main idea of an article; the work role creation is intended to provide a role foundation for subsequent creation of richer work content. These dimensions of work information can provide basic work materials for subsequent creation stages.

In specific implementations, after triggering to enter into the work creation process, the user may firstly enter the work scene setting stage; in this case, input prompt information for work scene setting may be displayed, the input prompt information may be, for example, a numerical range of input characters, prompts for the user to input background settings, and story direction, etc.; after the user inputs the work scene information in an input region according to the prompts, work synopsis information may be generated based on the work scene information input by the user by using the artificial intelligence technology, and the generated work synopsis information is displayed to the user. Next, if the user believes that there is something to be improved in the generated work synopsis information, the user may perform an edit operation thereon, and may perform a confirm operation on the edited work synopsis information after completing the edition; if the user agrees with the generated work synopsis information, the user may directly perform a confirm operation thereon. Then, based on the confirmed work synopsis information (which may also be combined with the initial work scene information), information of each role in the corresponding work may be generated and displayed by using the artificial intelligence technology; and the user may also perform the above edit operation and confirm operation on the information of each role.

Under this implementation, the generating initial work information may include three stages: work scene setting, work synopsis generation, and role generation, with information of each stage presented in an interface each time. In addition, here, at the beginning, the user only needs to input the work scene information, so as to automatically generate work synopsis; then, after the user edits and confirms the work synopsis, information of each role may be generated; and such process is carried out stage by stage, giving the user a sense of compact rhythm in interface display, which provides sufficient auxiliary functions for generation of the initial work information on the premise of fully considering the input content of the user, reduces difficulty for the user to input the initial work information and improves input efficiency of the initial work information.

For example, for any creation stage, real-time generation progress information of the current stage can be displayed. The embodiments of the present disclosure may be applied to a mobile terminal device such as a mobile phone. In response to cases of small screen region and limited interface display resources of the mobile terminal device, the embodiments of the present disclosure only have creation information of a current stage displayed in an interface each time, and the interface displays the real-time generation progress of AI, which can facilitate the user to understand the current stage and progress.

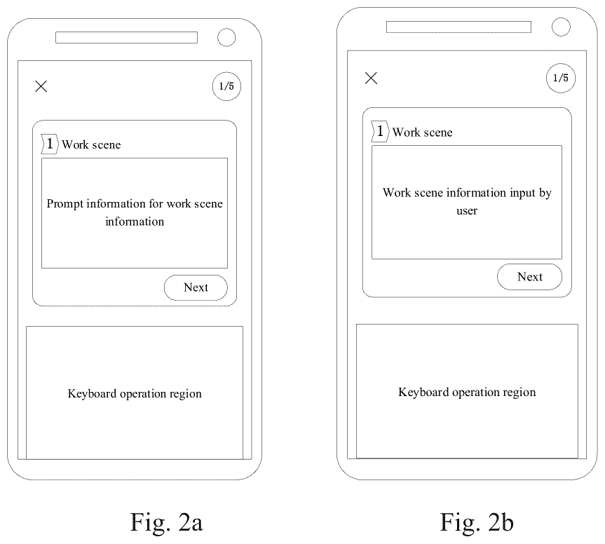

As shown in FIG. 2a, it is a schematic diagram of an interface before receiving the initial work information; in an input region of the interface, prompt information for inputting the work scene information is displayed in gray (indicating that the prompt information is non-editable); as shown in FIG. 2b, the user may input the work scene information in the input region of the interface according to the prompt information; after completing input of the work scene information, the user may enter a subsequent step by click a “Next” button. In addition, an upper right corner of the interface is further marked with a stage indicator indicating a current stage; the stage indicator is used to indicate the total number of creation stages and the currently ongoing creation stage; for example, when the current stage is the stage of inputting work scene information and is a first stage among all five stages of generating the target work, then an icon in the upper right corner is written with a word “1/5”. Here, the five stages of generating the target work include not only the work scene setting stage, the work synopsis creation stage, and the work role creation stage as described above, but also include a work summary outline creation stage and a work detailed outline creation stage as described subsequently.

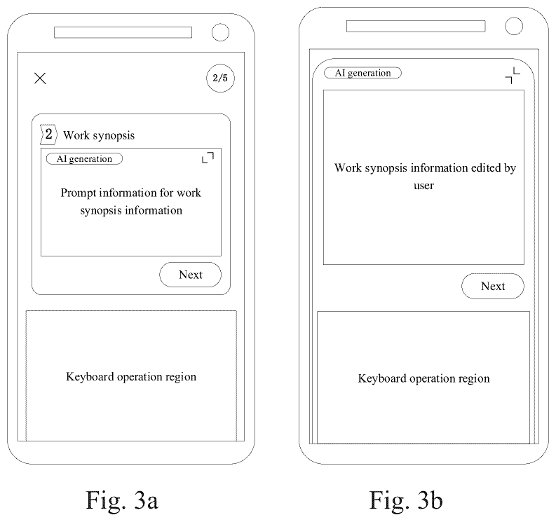

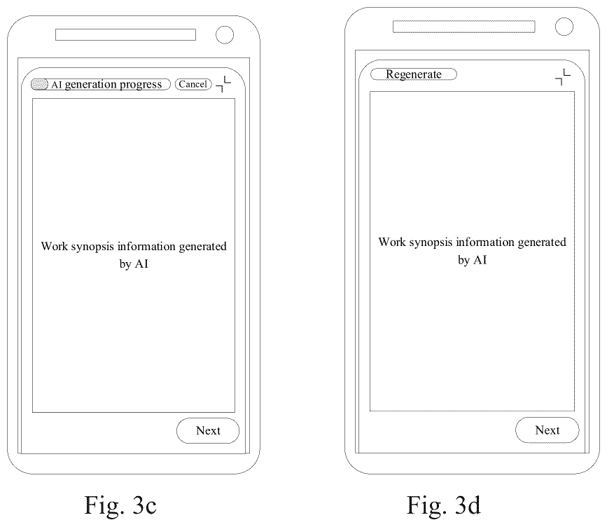

As shown in FIG. 3a, it is a display interface for entering a work synopsis creation stage from a previous stage; in an input region of the interface, prompt information for inputting work synopsis is displayed in gray (indicating that the prompt information is non-editable); the user may choose to input manually or trigger AI generation. The user may trigger the input region or a corner marker in an upper right corner of the input region to enter an edition state of the input region and manually edit the input, as shown in FIG. 3b. During the process of editing the input, the user may trigger an AI generation function (i.e., trigger an artificial intelligence identifier in the interface) at any time; in this case, an artificial intelligence module may automatically generate the remaining work synopsis information based on the portion of the input work synopsis information that has been edited by the user and the work scene information in the previous stage.

If the user triggers AI generation in the stage, the user will enter the interface shown in FIG. 3c. In order to facilitate displaying the generated work synopsis information results, a keyboard operation region is hidden in the interface. After the generation is completed, the keyboard operation region may be re-displayed for user to edit the generated results in the interface; in addition, to facilitate the user to monitor the generated results in real time, the displayed generation results are synchronized with the generation progress, that is, the currently generated content is displayed in real time, and the current generation progress is displayed in the interface. After completing the edit operation on the work synopsis information, the user may continue to enter a subsequent step by clicking a “Next” button.

Here, in the embodiments of the present disclosure, in any creation stage of the AI generation process, AI real-time generation progress information may be displayed, making it convenient for the user to understand the current stage and progress; and the real-time generation progress information includes progress bar indicator and progress value.

In addition, in any creation stage according to the embodiments of the present disclosure, the keyboard operation region may be switched between hide state and display state, meeting needs of content display and user edition.

In one implementation, the user may stop generating when the user feels that the results generated by AI are sufficient to meet requirements; or, when the user is dissatisfied with some of the results, the user may stop and cancel the process, and regenerate again.

That is, in a case where the AI created content is not completed, the user may initiate a cancel operation to stop the generation process of the artificial intelligence model, and in this case, the interface will display some of the AI generated results. In addition, after stopping generation, in response to a re-trigger operation for the artificial intelligence identifier, the created content generated before display may be cancelled, and updated created content generated by the artificial intelligence model in real time, as well as real-time generation progress information of the updated created content may be re-displayed from the beginning. Here, due to randomness of AI creation, the created content regenerated by AI may be different from the contented generated last time.

In this case, as shown in FIG. 3c, in addition to the above-described real-time generation progress information, a “Cancel” button may also be displayed in a corresponding position of the progress bar; the user may trigger the “Cancel” button to stop the generation process of the artificial intelligence model. As shown in FIG. 3d, the user triggers the “Regenerate” button, and in this case, AI regenerates a new work synopsis.

After the user confirms that there is no problem with the work synopsis information, the user may trigger a “Next” button to proceed to a next stage: work role creation stage.

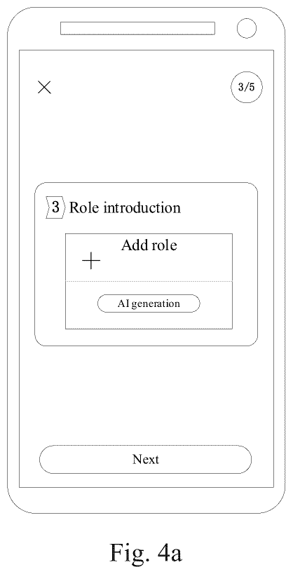

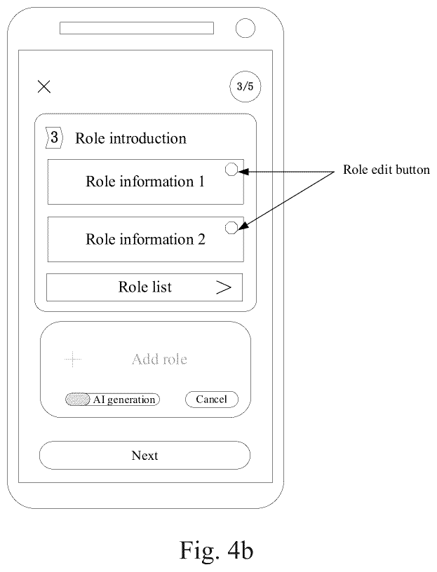

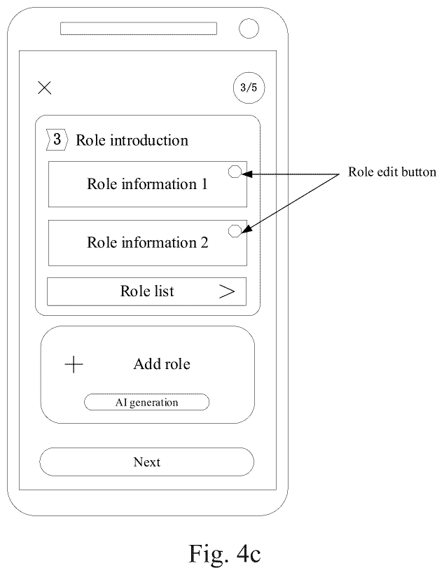

As shown in FIG. 4a, it is a display interface for entering a work role creation stage from a previous stage; in the interface, the user may choose to manually add role information or trigger AI generation. When the user chooses AI generation, the user will enter an AI generation result display page shown in FIG. 4b; similarly, the created content generated in real time and real-time generation progress information will be displayed during the generation process, and meanwhile, a “Cancel” button that may have cancellation triggered at any time will also be displayed. In order to conveniently and clearly display the generated information of each role, in the interface, each role has a role edition region corresponding thereto; the role edition region is used for displaying role identifier and description information of a role, and a “Role edit” button corresponding to the role. The user may edit corresponding role information by triggering the “Role edit” button corresponding to the role.

In FIG. 4a, when the user chooses to manually input role information, the user may manually perform a role add operation by triggering an “Add role” button in the interface. After manually adding the role information, the interface as shown in FIG. 4c is displayed. The interface displays the role information manually added by the user and the artificial intelligence identifier; during the process of adding roles, the user may trigger the artificial intelligence identifier at any time to automatically generate subsequent role information. In addition, a complete role list may be updated and displayed by triggering a “Role list” button; the role list may include a role edition region for each role, the role edition region includes corresponding role identifier and role description information, and a “Role edit” button corresponding to the role. After completing the edit operation and the add operation for the role information, the user may proceed to a subsequent step by clicking a “Next” button at the bottom of the interface.

S102: displaying supplementary prompt information generated according to the initial work information; in which the supplementary prompt information is used for prompting supplementation of the initial work information under a target dimension.

In the step, the initial work information may be analyzed, and the supplementary prompt information may be generated and displayed according to the analysis result; the supplementary prompt information is used for reminding the user to supplement description of the initial work information under the supplementary dimension obtained through analysis; and the supplementary dimension may include, for example, conflicts between roles, historical background of the story, etc.

In specific implementation, in addition to generating and displaying the supplementary prompt information, candidate supplementary information corresponding to the supplementary prompt information may also be generated and displayed. Specifically, the supplementary prompt information may also be used to prompt the user to supplement the initial work information under a plurality of dimensions, to improve richness of the initial work information and further enhance richness of the target work generated based on the initial work information; when the user cannot independently supplement the initial work information according to the supplementary prompt information, the user may also supplement the initial work information by selecting candidate supplementary information matching the work from the provided candidate supplementary information corresponding to the supplementary prompt information.

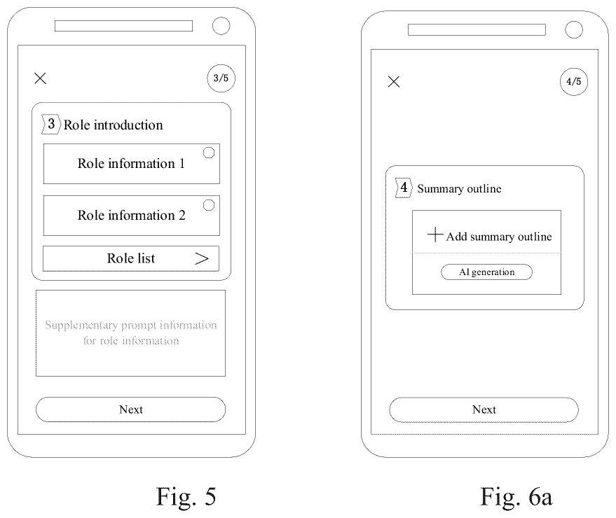

The supplementary prompt information may be displayed at any stage in the stages such as the work scene setting stage, the work synopsis generation stage, and the work role generation stage as described above. For example, after inputting the work scene information, and after triggering a “Next” button to enter the next step, the artificial intelligence model may automatically give supplementary prompt information. Usually, the supplementary prompt information may be provided in the case where the user manually inputs the created content, while in the case where the artificial intelligence model automatically generates the created content, the supplementary prompt information may not be displayed. As shown in FIG. 5, it is a display interface for the supplementary prompt information in the work role creation stage; in response to a trigger operation on a “Next” button in the interface after the user inputs the role information, the artificial intelligence module analyzes that there are shortcomings of the current created content and may display the supplementary prompt information directly on the current page without entering a next stage page, so that the user may further input relevant content on the current page. In the interface, in order to better display the supplementary prompt information and the candidate supplementary information corresponding to the supplementary prompt information, the keyboard operation region is hidden. The user may input on the current result page based on the supplementary prompt information, or may also select corresponding candidate supplementary information through a trigger operation on the candidate supplementary information, to complete a supplement operation on the initial work information under the target dimension; and after completing the above-described operation, the user may enter a subsequent generation step by clicking a “Next” button in the interface.

S103: generating and displaying work outline information according to the initial work information supplemented based on the supplementary prompt information; in which the work outline information includes work summary outline information and work detailed outline information, each summary outline corresponds to a plurality of work detailed outlines.

In the embodiments of the present disclosure, the work summary outline information may be generated and displayed by using the artificial intelligence model based on the supplemented initial work information, information of each work summary outline corresponds to a chapter; the user may perform a trigger operation on information of any summary outline, to send a detailed outline generation request for this summary outline, to generate information of a plurality of work detailed outlines under a chapter corresponding to this summary outline. After completing the work detailed outline information, the work detailed outline information is displayed; when there is new work role information (new addition to the role information as compared with the previous stage) generated for a target chapter in the work detailed outline information, first detailed outline prompt information will be displayed, to remind the user that a new role has been generated for the target chapter; and role information corresponding to the newly generated role may include role attribute information and relationship information with other roles.

Here, when displaying the work detailed outline, newly added work role information of the generated detailed outline as compared with the summary outline, etc. of the previous stage is also displayed, so that the user has a clearer expectation of the work to be generated.

In the embodiments of the present disclosure, after obtaining the AI generated work outline information, the user may also input feedback suggestion information; the feedback suggestion information includes suggestion information for at least one outline attribute, for example, the number of entries of outline information, information such as plot requirements for each outline, etc., so that the artificial intelligence model can regenerate the outline information of the work based on the feedback suggestion information and the initial work information.

By adopting the above implementation, when the user believes that there is room for improvement in the outline information generated for the first time, the user may put further requirements on the outline information through the feedback suggestion information, to regenerate new work outline information that meets requirements of the user, which may involve the user in the process of generating the final target work, ensure that the target work generated based on the outline information meets requirements of the user, and improve quality of the target work.

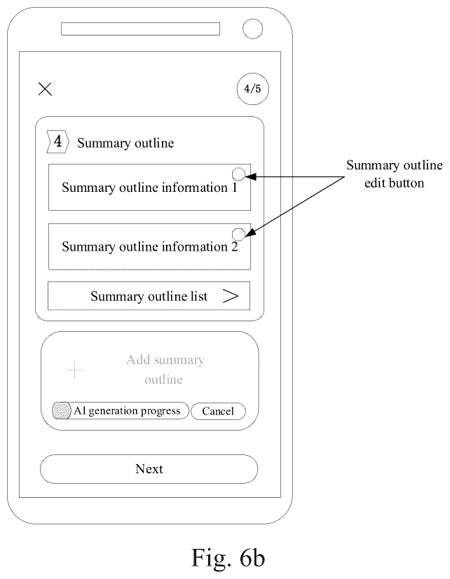

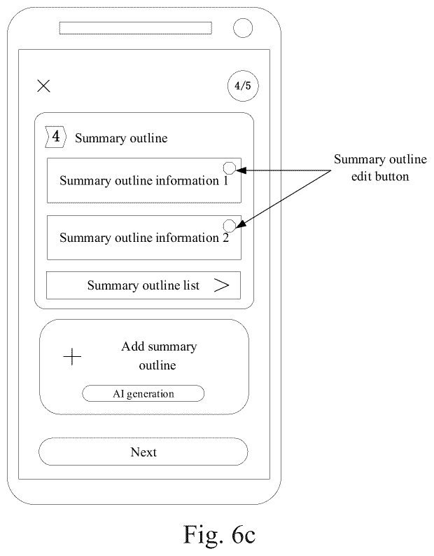

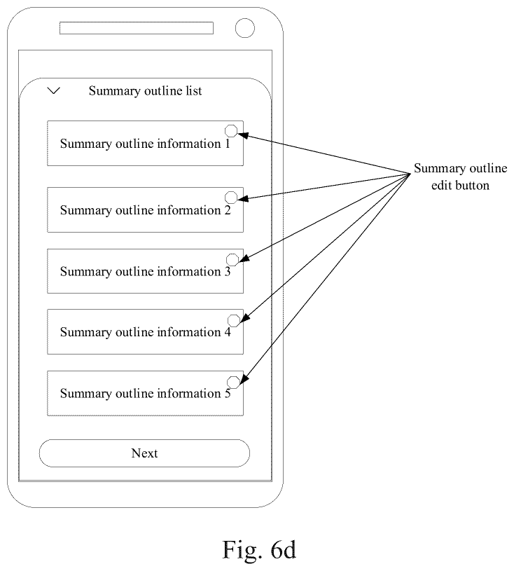

As shown in FIG. 6a, it is a display interface for entering a work summary outline creation stage from a previous stage. In the interface, the user may choose to manually add summary outline information or trigger AI generation. When the user chooses AI generation, the user will enter an AI generation result display page as shown in FIG. 6b; similarly, the created content generated in real time and the real-time generation progress information will be displayed during the generation process, and meanwhile, a “Cancel” button that may have cancellation triggered at any time will also be displayed.

In FIG. 6a, when the user chooses to manually input the summary outline information, the user may manually perform an operation of manually adding the summary outline by triggering an “Add summary outline” button in the interface; after manually adding the summary outline information, the interface as shown in FIG. 6c is displayed. The interface displays the summary outline information manually added by the user and the artificial intelligence identifier. During the process of adding the summary outline information, the user may trigger the artificial intelligence identifier at any time to automatically generate subsequent summary outline information. In addition, a complete summary outline list may be updated and displayed by triggering a “Summary outline list” button, as shown in FIG. 6d; the summary outline list may include an edition region for each summary outline, the edition region includes a corresponding summary outline number and summary outline description information, as well as an edit button corresponding to the summary outline. After completing the edit operation and the add operation on the summary outline information, the user may continue to enter a subsequent step by clicking a “Next” button at the bottom of the interface.

In the interface, in order to facilitate displaying information of a plurality of work summary outlines, the keyboard operation region is hidden; after the artificial intelligence model completes generation of the work summary outline information, the keyboard operation region is re-displayed, so that the user may edit the work summary outline information based on the keyboard operation region; specifically, the user may edit the summary outline information of the summary outline by using the keyboard operation region, through triggering a “Summary outline edit” button corresponding to the target category.

It should be noted that, in order to facilitate the user to monitor the generated summary outline result in real time, the interface further displays the currently generated work summary outline information in real time, and displays the current real-time generation progress in the interface. After completing the edit operation on the work summary outline information, the user may continue to enter a subsequent detailed outline generation stage by clicking a “Next” button.

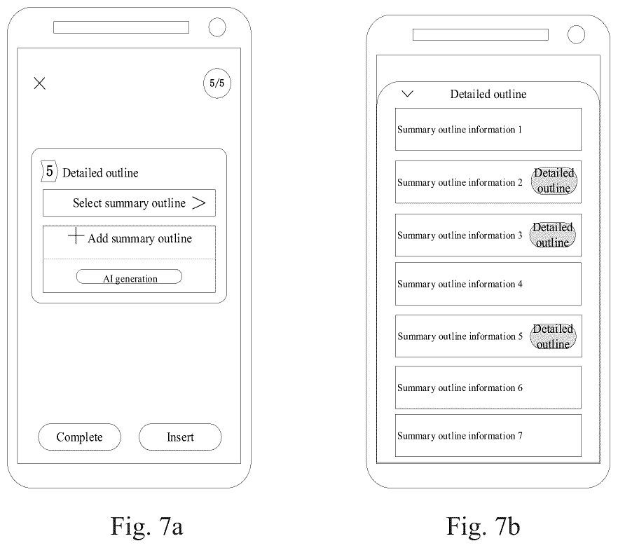

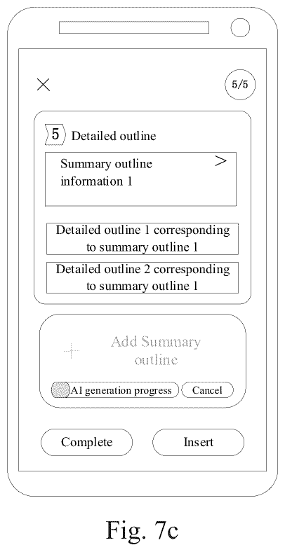

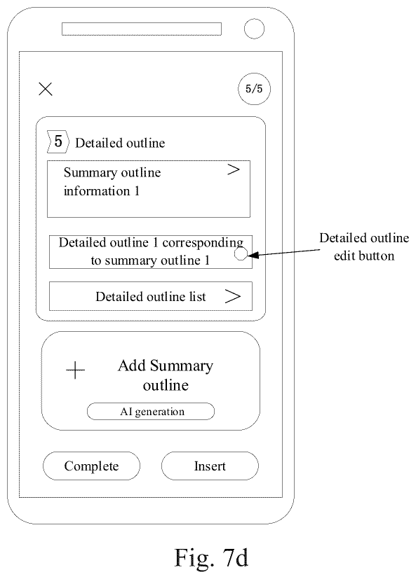

As shown in FIG. 7a, it is a display interface for entering a work detailed outline creation stage from a previous stage; in the interface, the user may choose to manually add detailed outline information, or may also trigger AI generation. The user may trigger a “Select summary outline” button, and in this case, a summary outline list will be displayed in a display panel, as shown in FIG. 7b. The user may select a summary outline in the summary outline list, and then trigger AI generation or trigger to manually add detailed outline information.

After triggering AI generation, an AI generation result display page is entered, as shown in FIG. 7c; similarly, the created content generated in real time and the real-time generation progress information will be displayed during the generation process, and meanwhile, a “Cancel” button that may have cancellation triggered at any time will also be displayed.

After generating each detailed outline under a certain summary outline, as shown in FIG. 7d, an edition region of each detailed outline under one summary outline may be displayed; the edition region displays corresponding detailed outline number and detailed outline description information, as well as an edit button corresponding to the detailed outline. After completing the edit operation and the add operation on the detailed outline information, the user may continue to enter a subsequent step by clicking a “Next” button at the bottom of the interface.

In one implementation, when displaying the work detailed outline information, second detailed outline prompt information may also be displayed, the second detailed outline prompt information includes supplementary suggestion information for the detailed outline information; the user may supplement plot information and/or role information in the detailed outline according to the supplementary suggestion information corresponding to the second detailed outline prompt information.

Under such implementation, the user provides further supplementary suggestion on the detailed outline, which may help the user further improve plot and role settings of intermediate stages, making the final generated work detailed and richer.

In the embodiments of the present disclosure, when the user performs a supplementary edit operation on the above summary outline information and detailed outline information, the user needs to determine the updated summary outline information and detailed outline information, determine remaining summary outline information and detailed outline information associated therewith, and update the remaining summary outline information and detailed outline information according to the updated summary outline information and detailed outline information.

In such implementation, when the user modifies a portion of the outline, roles, plots, etc. of the remaining chapter outlines may be affected. Therefore, based on contextual relationships, adaptive updates may be made to the remaining outlines affected, thereby improving logical rigor and smoothness of the overall text story.

S104: generating and displaying a target work corresponding to the work outline information in response to a work generation request initiated based on the work outline information.

In the step, the user may perform a select operation on at least one entry of work outline information, use an artificial intelligence model, based on the initial work information and the selected work outline information, to initiate a work generation request through, so as to make the artificial intelligence model generate and display the target work.

In a specific implementation, at least one detailed outline of at least one summary outline may be selected to generate the work information. Here, the work may also be generated based on all the summary outlines and detailed outlines at once, or the work may also be generated by selecting some of the summary outlines and detailed outlines, for example, generated by selecting only one detailed outline of one summary outline each time.

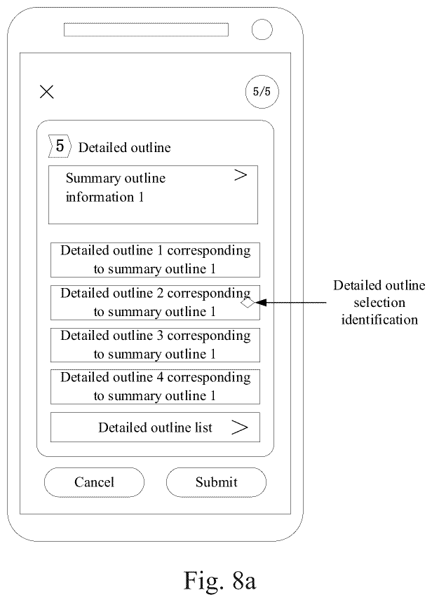

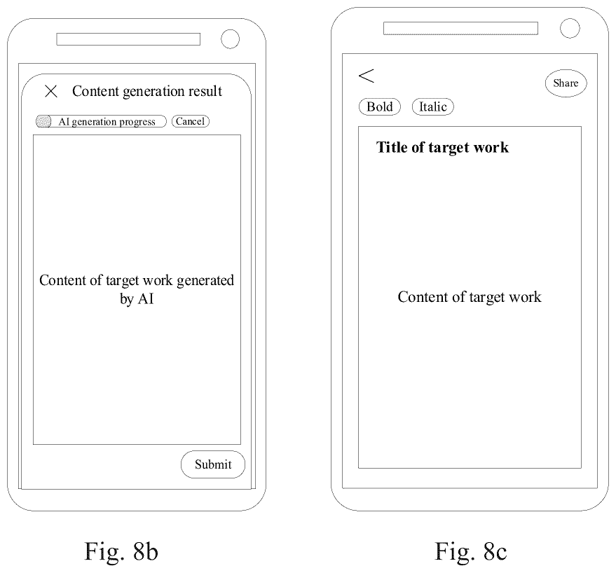

As shown in FIG. 8a, it is a schematic diagram of an interface for selecting a detailed outline. FIG. 8b is a schematic diagram of generating the work information based on the selected detailed outline. Similarly, the interface displays a real-time generation result and real-time generation progress information. As shown in FIG. 8c, it is a schematic diagram of an interface for finally generating a target work. The interface includes a title and main content of the finally generated target work, as well as relevant function buttons, for example, buttons such as “Bold” and “Italic” that may edit a format of text information in the target work, and for example, a “Share” button that may share the generated target work with other application software, and so on.

Those skilled in the art may understand that in the above-described method according to the specific implementations, the order of the respective steps does not imply a strict execution order or impose any limitations on the implementation process; and the specific execution order of the respective steps should be determined by a function and possible internal logic thereof.

Based on a same invention concept, the embodiments of the present disclosure further provide a work generating apparatus corresponding to the work generating method. Since the principle on which the apparatus solves the problem according to the embodiments of the present disclosure is similar to that of the above-described work generating method according to the embodiments of the present disclosure, the implementation of the method may be referred to for implementation of the apparatus, and no details will be repeated here.

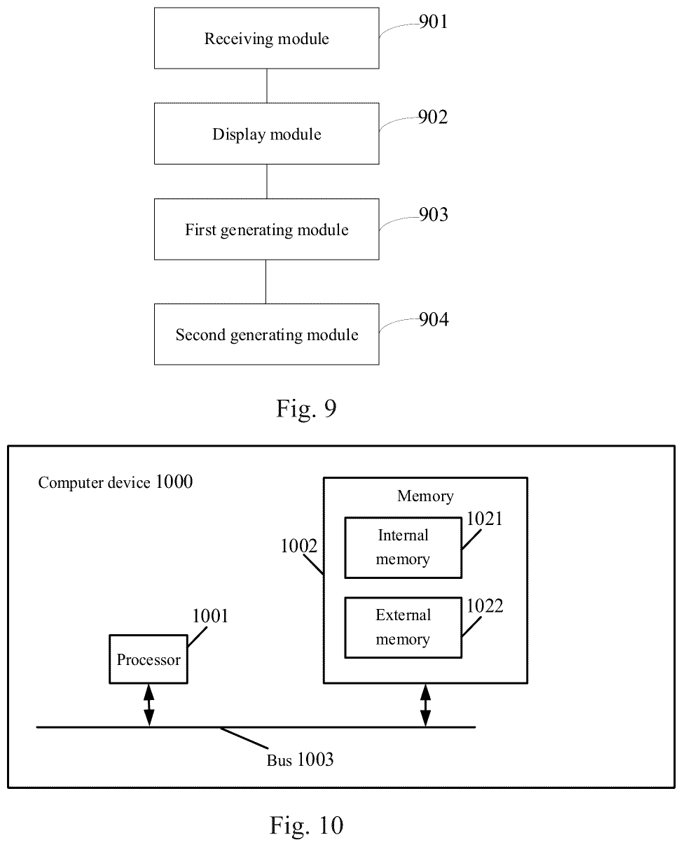

Referring to FIG. 9, it is a structural schematic diagram of a work generating apparatus 900 provided by an embodiment of the present disclosure, the apparatus includes a receiving module 901, a display module 902, a first generating module 903 and a second generating module 904.

The receiving module 901 is configured to receive initial work information under a plurality of dimensions input by user; the plurality of dimensions include at least one selected from a group consisting of work scene, work role and work synopsis.

The display module 902 is configured to display supplementary prompt information generated according to the initial work information; the supplementary prompt information is used for prompting supplementation of the initial work information under a target dimension.

The first generating module 903 is configured to generate and display work outline information according to the initial work information supplemented based on the supplementary prompt information; the work outline information includes work summary outline information and work detailed outline information, each work summary outline corresponds to a plurality of detailed outlines.

The second generating module 904 is configured to generate and display a target work corresponding to the work outline information in response to a work generation request initiated based on the work outline information.

In one possible implementation, the display module 902 is specifically configured to:

display the supplementary prompt information and candidate supplementary information corresponding to the supplementary prompt information; and

acquire initial work information under the target dimension that the user has re-edited based on the supplementary prompt information; or, determine target supplementary information selected by the user from the candidate supplementary information, and determine the initial work information supplemented based on the target supplementary information.

In one possible implementation, the first generating module 903 is further configured to:

receive feedback suggestion information input by the user for the work outline information, in which the feedback suggestion information includes suggestion information for at least one outline attribute; and

regenerate the work outline information according to feedback suggestion information and the initial work information.

In one possible implementation, the first generating module 903 is further configured to:

receive an edit operation performed by the user on a portion of outline information in the work outline information, determine the portion of outline information updated, and determine remaining outline information associated with the portion of outline information; and

update the remaining outline information according to the portion of outline information updated.

In one possible implementation, the first generating module 903 is further configured to:

generate and display the work summary outline information based on the initial work information supplemented; in which each entry of work summary outline information corresponds to a chapter;

generate work detailed outline information under a target chapter corresponding to the work summary outline information in response to a detailed outline generation request of any entry of work summary outline information; and

display the work detailed outline information and first detailed outline prompt information; in which the first detailed outline prompt information is used for prompting new work role information generated for the target chapter; and the new work role information includes role attribute information and relationship information with other roles.

In one possible implementation, the first generating module 903 is further configured to:

display second detailed outline prompt information when displaying the work detailed outline information; in which the second detailed outline prompt information includes supplementary suggestion information for the work detailed outline information, the supplementary suggestion information includes plot suggestion information and/or role suggestion information; and

determine the work detailed outline information after the user edits the work detailed outline based on the second detailed outline prompt information.

In one possible implementation, the first receiving module 901 is specifically configured to:

receive work scene information input by the user;

display the work synopsis information generated based on the work scene information; and

in response to an edit confirm operation for the work synopsis information, display information of each role generated based on the work synopsis information.

In one possible implementation, the first generating module 903 is specifically configured to:

display work outline information generated by an artificial intelligence model in real time, and real-time generation progress information corresponding to the work outline information.

In one possible implementation, the first generating module 903 is specifically configured to:

hide a keyboard operation region used for user edition in a process of generating the work outline information by the artificial intelligence model in real time, to expand a display region of a content generated by the artificial intelligence model; and

display the keyboard operation region after the artificial intelligence model has generated the work outline information, to facilitate the user to edit the work outline information based on the keyboard operation region.

The relevant description in the above method embodiments may be referred to for description of a processing flow of respective modules and an interaction flow between the respective modules in the apparatus; and no details will be repeated here.

Corresponding to the work generating method in FIG. 1, the embodiments of the present disclosure further provide an electronic device, such as a computer device 1000, as shown in FIG. 10, which is a structural schematic diagram of the computer device 1000 provided by an embodiment of the present disclosure, the electronic device, such as the computer device 1000, includes a processor 1001, a memory 1002, and a bus 1003.

The memory 1002 is configured to store execution instructions, and includes an internal memory 1021 and an external memory 1022; here the internal memory 1021 is also referred to as a built-in memory, and is configured to temporarily store operation data in the processor 1001 and data exchanged with the external memory 1022 such as a hard disk; the processor 1001 exchanges data with the external memory 1022 through the internal memory 1021; when the computer device 1000 is running, the processor 1001 communicates with the memory 1002 through the bus 1003, causing the processor 1001 to execute instructions below:

receiving initial work information under a plurality of dimensions input by a user; in which the plurality of dimensions include at least one selected from a group consisting of work scene, work role and work synopsis;

displaying supplementary prompt information generated according to the initial work information; in which the supplementary prompt information is used for prompting supplementation of the initial work information under a target dimension;

generating and displaying work outline information according to the initial work information supplemented based on the supplementary prompt information; in which the work outline information includes work summary outline information and work detailed outline information, each summary outline corresponds to a plurality of work detailed outlines; and

generate and display a target work corresponding to the work outline information in response to a work generation request initiated based on the work outline information.

The embodiments of the present disclosure further provide a computer readable storage medium, the computer readable storage medium stores a computer program thereon; when the computer program is run by a processor, steps of the work generating method in the above method embodiments are executed. The storage medium may be a transitory or non-transitory computer-readable storage medium.

The embodiments of the present disclosure further provide a computer program product, the computer program product carries a program code, which includes instructions that can be used to execute the steps of the work generating method described in the above method embodiments. Please refer to the above method embodiments for details, which is not be repeated here.

The computer program product can be specifically implemented through hardware, software, or a combination thereof. In one optional embodiment, the computer program product is specifically implemented as a computer storage medium, while in another optional embodiment, the computer program product is specifically implemented as a software product, such as a software development kit (SDK), etc.

Those skilled in the field can clearly understand that for the convenience and conciseness of description, the specific working process of the system and device described above can refer to the corresponding process in the aforementioned method embodiments, and will not be repeated here. In several embodiments provided in the present disclosure, it should be understood that the disclosed apparatus, device, and method may be implemented in other ways. The device embodiments described above are only illustrative. For example, the division of the modules is only a logical function division, and there may be other division methods in actual implementation. For example, multiple modules or components can be combined or integrated into another system, or some features can be ignored or not executed. In addition, the coupling or direct coupling or communication connection shown or described can be indirect coupling or communication connection through some communication interfaces, devices or modules, which can be electrical, mechanical or in other forms.

The modules described as separate components may be or not be physically separated, and the components shown as modules may be or not be physical modules, that is, they can be located in one place or distributed in multiple network modules. Some or all modules can be selected according to actual needs to achieve the purpose of the embodiments.

In addition, in various embodiments of the present disclosure, each functional module may be integrated into one processing module, or each module may physically exist separately, or two or more modules may be integrated into one module.

When the functions are implemented in the form of software functional modules and sold or used as independent products, they can be stored in a non-transitory computer-readable storage medium that can be executed by a processor. Based on this understanding, at least part of the technical solutions of the present disclosure can be in the form of a software product. The computer software product is stored in a storage medium and includes several instructions to enable a computer device (which can be a personal computer, server, or network device, etc.) to perform all or part of the steps of the methods described in the various embodiments of the present disclosure. The storage medium includes: a USB flash drive, a portable hard drive, a read only memory (ROM), a random access memory (RAM), a disk, a CD, or other media that can store program code.

Finally, it should be noted that the above embodiments are only specific implementations of the present disclosure, used to illustrate the technical solutions of the present disclosure, and not to limit the present disclosure. The protection scope of the present disclosure is not limited to this. Although detailed explanations of the present disclosure have been made with reference to the aforementioned embodiments, ordinary technical personnel in the art should understand that any technical personnel familiar with the art can still modify or easily think of changes to the technical solutions recorded in the aforementioned embodiments within the scope of the disclosed technology, or replace some of the technical features equally; and these modifications, changes, or replacements are all within the spirit and scope of the technical solutions of the present disclosure, and should be covered within the protection scope of the present disclosure. Therefore, the protection scope of the present disclosure should be based on the claims.

1. A work generating method, comprising:
receiving initial work information under a plurality of dimensions input by a user; wherein the plurality of dimensions comprise at least one selected from a group consisting of work scene, work role and work synopsis;
displaying supplementary prompt information generated according to the initial work information; wherein the supplementary prompt information is used for prompting supplementation of the initial work information under a target dimension;
generating and displaying work outline information according to the initial work information supplemented based on the supplementary prompt information; wherein the work outline information comprises work summary outline information and work detailed outline information, each summary outline corresponds to a plurality of work detailed outlines; and
in response to a work generation request initiated based on the work outline information, generating and displaying a target work corresponding to the work outline information.

2. The method according to claim 1, wherein the displaying supplementary prompt information generated according to the initial work information comprises:
displaying the supplementary prompt information and candidate supplementary information corresponding to the supplementary prompt information; and
acquiring initial work information under the target dimension that the user has re-edited based on the supplementary prompt information; or, determining target supplementary information selected by the user from the candidate supplementary information, and determining the initial work information supplemented based on the target supplementary information.

3. The method according to claim 1, wherein, before the generating a target work corresponding to the work outline information in response to a work generation request initiated based on the work outline information, the method further comprises:
receiving feedback suggestion information input by the user for the work outline information, wherein the feedback suggestion information comprises suggestion information for at least one outline attribute; and
regenerating the work outline information according to feedback suggestion information and the initial work information.

4. The method according to claim 1, wherein, after the generating the work outline information, and before the receiving the work generation request, the method further comprises:
receiving an edit operation performed by the user on a portion of outline information in the work outline information, determining the portion of outline information updated, and determining remaining outline information associated with the portion of outline information; and
updating the remaining outline information according to the portion of outline information updated.

5. The method according to claim 1, wherein, the generating work outline information according to initial work information supplemented based on the supplementary prompt information, comprises:
generating and displaying the work summary outline information based on the initial work information supplemented; each entry of work summary outline information corresponding to a chapter;
generating work detailed outline information under a target chapter corresponding to the work summary outline information in response to a detailed outline generation request of any entry of work summary outline information; and
displaying the work detailed outline information and first detailed outline prompt information; wherein the first detailed outline prompt information is used for prompting new work role information generated for the target chapter; and the new work role information comprises role attribute information and relationship information with other roles.

6. The method according to claim 5, further comprising:
displaying second detailed outline prompt information when displaying the work detailed outline information; wherein the second detailed outline prompt information comprises supplementary suggestion information for the work detailed outline information, the supplementary suggestion information comprises plot suggestion information and/or role suggestion information; and
determining the work detailed outline information after the user edits the work detailed outline based on the second detailed outline prompt information.

7. The method according to claim 1, wherein, the receiving initial work information under a plurality of dimensions input by a user, comprises:
receiving work scene information input by the user;
displaying work synopsis information generated based on the work scene information; and
in response to an edit confirm operation for the work synopsis information, displaying information of each role generated based on the work synopsis information.

8. The method according to claim 1, wherein, the generating and displaying work outline information, comprises:
displaying work outline information generated by an artificial intelligence model in real time, and real-time generation progress information corresponding to the work outline information.

9. The method according to claim 8, wherein, the displaying work outline information generated by the artificial intelligence model in real time, and real-time generation progress information corresponding to the work outline information, comprises:
hiding a keyboard operation region used for user edition in a process of generating the work outline information by the artificial intelligence model in real time, to expand a display region of a content generated by the artificial intelligence model; and
displaying the keyboard operation region after the artificial intelligence model has generated the work outline information, to facilitate the user to edit the work outline information based on the keyboard operation region.

10. An electronic device, comprising a processor, a memory, and a bus, wherein the memory stores computer-readable instructions executable by the processor; and when the electronic device is running, the processor communicates with the memory through the bus, and the computer-readable instructions, when executed by the processor, execute steps of a work generating method, the method comprises:
receiving initial work information under a plurality of dimensions input by a user; wherein the plurality of dimensions comprise at least one selected from a group consisting of work scene, work role and work synopsis;
displaying supplementary prompt information generated according to the initial work information; wherein the supplementary prompt information is used for prompting supplementation of the initial work information under a target dimension;
generating and displaying work outline information according to the initial work information supplemented based on the supplementary prompt information; wherein the work outline information comprises work summary outline information and work detailed outline information, each summary outline corresponds to a plurality of work detailed outlines; and
in response to a work generation request initiated based on the work outline information, generating and displaying a target work corresponding to the work outline information.

11. The electronic device according to claim 10, wherein the displaying supplementary prompt information generated according to the initial work information comprises:
displaying the supplementary prompt information and candidate supplementary information corresponding to the supplementary prompt information; and
acquiring initial work information under the target dimension that the user has re-edited based on the supplementary prompt information; or, determining target supplementary information selected by the user from the candidate supplementary information, and determining the initial work information supplemented based on the target supplementary information.

12. The electronic device according to claim 10, wherein, before the generating a target work corresponding to the work outline information in response to a work generation request initiated based on the work outline information, the method further comprises:
receiving feedback suggestion information input by the user for the work outline information, wherein the feedback suggestion information comprises suggestion information for at least one outline attribute; and
regenerating the work outline information according to feedback suggestion information and the initial work information.

13. The electronic device according to claim 10, wherein, after the generating the work outline information, and before the receiving the work generation request, the method further comprises:
receiving an edit operation performed by the user on a portion of outline information in the work outline information, determining the portion of outline information updated, and determining remaining outline information associated with the portion of outline information; and
updating the remaining outline information according to the portion of outline information updated.

14. The electronic device according to claim 10, wherein, the generating work outline information according to initial work information supplemented based on the supplementary prompt information, comprises:
generating and displaying the work summary outline information based on the initial work information supplemented; each entry of work summary outline information corresponding to a chapter;
generating work detailed outline information under a target chapter corresponding to the work summary outline information in response to a detailed outline generation request of any entry of work summary outline information; and
displaying the work detailed outline information and first detailed outline prompt information; wherein the first detailed outline prompt information is used for prompting new work role information generated for the target chapter; and the new work role information comprises role attribute information and relationship information with other roles.

15. The electronic device according to claim 14, further comprising:
displaying second detailed outline prompt information when displaying the work detailed outline information; wherein the second detailed outline prompt information comprises supplementary suggestion information for the work detailed outline information, the supplementary suggestion information comprises plot suggestion information and/or role suggestion information; and
determining the work detailed outline information after the user edits the work detailed outline based on the second detailed outline prompt information.

16. The electronic device according to claim 10, wherein, the receiving initial work information under a plurality of dimensions input by a user, comprises:
receiving work scene information input by the user;
displaying work synopsis information generated based on the work scene information; and
in response to an edit confirm operation for the work synopsis information, displaying information of each role generated based on the work synopsis information.

17. The electronic device according to claim 10, wherein, the generating and displaying work outline information, comprises:
displaying work outline information generated by an artificial intelligence model in real time, and real-time generation progress information corresponding to the work outline information.

18. The electronic device according to claim 17, wherein, the displaying work outline information generated by the artificial intelligence model in real time, and real-time generation progress information corresponding to the work outline information, comprises:
hiding a keyboard operation region used for user edition in a process of generating the work outline information by the artificial intelligence model in real time, to expand a display region of a content generated by the artificial intelligence model; and
displaying the keyboard operation region after the artificial intelligence model has generated the work outline information, to facilitate the user to edit the work outline information based on the keyboard operation region.

19. A non-transitory computer readable storage medium, storing a computer program thereon; wherein the computer program, when run by a processor, executes a work generating method, the method comprises:
receiving initial work information under a plurality of dimensions input by a user; wherein the plurality of dimensions comprise at least one selected from a group consisting of work scene, work role and work synopsis;
displaying supplementary prompt information generated according to the initial work information; wherein the supplementary prompt information is used for prompting supplementation of the initial work information under a target dimension;
generating and displaying work outline information according to the initial work information supplemented based on the supplementary prompt information; wherein the work outline information comprises work summary outline information and work detailed outline information, each summary outline corresponds to a plurality of work detailed outlines; and
in response to a work generation request initiated based on the work outline information, generating and displaying a target work corresponding to the work outline information.
